(19) United States
(12) Patent Application Publication
(10) Pub. No.: US 2026/0154173 A1
(43) Pub. Date: Jun. 4, 2026

(54) QUALITY SCORING BASED UPON DEVICE LOGS

(71) Applicant: Lenovo Global Technology (United States) Inc., Morrisville, NC (US)

(72) Inventors: Robert James Norton, JR., Raleigh, NC (US); Robert Furda, Bratislava (SK); Henry Svendsgaard, Raleigh, NC (US)

(21) Appl. No.: 18/967,097

(22) Filed: Dec. 3, 2024

(51) Int. Cl. G06F 11/34

(52) U.S. Cl. CPC G06F 11/3409; G06F 11/3476

(57) ABSTRACT

One embodiment provides a method, the method including: capturing, using a device quality analysis system, an initial log for a device, wherein the initial log includes information corresponding to hardware and software logs for the device; initiating, for the device, a continuous logging that records, within a device log, information related to hardware components and software components of the device; and providing, responsive to receiving a query, a device quality score for the device, wherein the providing includes dynamically determining, using the device quality analysis system, the device quality score based upon the information contained within the device log and in view of the initial log. Other aspects are claimed and described.

### BACKGROUND

Leasing devices is popular for entities who may need one or more electronic devices without having the cost of the maintenance and full upfront cost of each device. Additionally, leasing devices provides the flexibility to the entity to obtain devices having the latest features and components or to otherwise ensure that the devices being used are those devices that have the features and components that are most needed by the entity at any particular time. To lease a device an entity generally pays a cost for use of the device at predetermined intervals, for example, the entity may pay a monthly fee for the use of the device. A providing entity provides the devices having the requested features and components to the lessee entity and the lessee entity then pays the agreed upon fee. The lease has a term period and at the end of the term period the lessee entity may be able to decide what to do with the device, such as renewing the lease, purchasing the device outright, or returning the device to the providing entity.

### BRIEF SUMMARY

In summary, one aspect provides a method, the method including: capturing, using a device quality analysis system, an initial log for a device, wherein the initial log includes information corresponding to hardware and software logs for the device; initiating, for the device, a continuous logging that records, within a device log, information related to hardware components and software components of the device; and providing, responsive to receiving a query, a device quality score for the device, wherein the providing includes dynamically determining, using the device quality analysis system, the device quality score based upon the information contained within the device log and in view of the initial log.

Another aspect provides a system, the system including: a processor; a memory device that stores instructions that, when executed by the processor, causes the system to: capture, using a device quality analysis system, an initial log for a device, wherein the initial log includes information corresponding to hardware and software logs for the device; initiate, for the device, a continuous logging that records, within a device log, information related to hardware components and software components of the device; and provide, responsive to receiving a query, a device quality score for the device, wherein the providing includes dynamically determining, using the device quality analysis system, the device quality score based upon the information contained within the device log and in view of the initial log.

A further aspect provides a product, the product including: a computer-readable storage device that stores executable code that, when executed by a processor, causes the product to: capture, using a device quality analysis system, an initial log for a device, wherein the initial log includes information corresponding to hardware and software logs for the device; initiate, for the device, a continuous logging that records, within a device log, information related to hardware components and software components of the device; and provide, responsive to receiving a query, a device quality score for the device, wherein the providing includes dynamically determining, using the device quality analysis system, the device quality score based upon the information contained within the device log and in view of the initial log.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for determining and providing a device quality for a device based upon continuous logs that record information related to hardware and software components of the device.

### DETAILED DESCRIPTION

If the lessee entity chooses to return the device to the providing entity, the providing entity has to decide what to do with the device. For example, the providing entity may refurbish the device and provide it to another entity to utilize, scrap the device, sell the device to a third-party who may refurbish or scrap the device, and/or the like. The problem with deciding how to disposition the device is that the providing entity is not well aware of the condition of the device upon getting the device back from the lessee entity. The providing entity can perform a visual inspection of the device to determine if there is any significant or cosmetic damage, but regardless of whether this damage exists, it may not provide an accurate representation of the quality of the device. For example, a device may have a broken screen which causes it to be non-functional. This may result in the device appearing to be inoperable. However, it could simply be that the screen is broken and the remaining components of the device are in good condition. As another example, a device may appear to be undamaged, but thermal events throughout the lifespan of the device may have damaged the motherboard or other sensitive components to the point that the device will soon be inoperable.

A providing entity could perform other cursory inspections of the device that may provide additional details regarding the operability of the device. For example, the providing entity could attempt to power on the device, could perform systems checks, could perform different tests, and/or the like. However, each test or inspection that is completed takes even more time with respect to dispositioning the device. If the device has any components that are damaged so as to prevent one or more of these tests from being completed, even more time has to be taken to perform these tests. While the devices could be still valuable to the providing entity, the cost of performing such tests and inspections quickly adds up.

Thus, instead of performing these tests and inspections, the providing entity may instead assume that the devices are inoperable regardless of an actual status of the device and sell them (e.g., in bulk) to a third-party, and may sell the device at a discount relative to its expected present value. The third-party can then perform the analyses on the devices and further disposition the devices. However, as could readily be understood, the providing entity could be leaving a significant amount of money on the table. If the providing entity had a more accurate and quick technique to determine the quality of the device, the providing entity could more accurately disposition the device. Additionally, by more accurately dispositioning the device, the providing entity could reduce an amount of device waste and extend a useful lifespan of the device and/or the components thereof.

Accordingly, the described system and method provides a technique for determining and providing a device quality for a device based upon continuous logs that record information related to hardware and software components of the device. The system captures an initial log for a device. Using the example where a device is provided to a lessee entity, the initial log for the device may be captured before the device is provided to the lessee entity. However, the initial log can be captured at any time. In addition to capturing the initial log, the system may determine an initial device quality score for the device. The initial device quality score may provide an indication of the quality of the device. The initial device quality score may be an aggregate of initial component quality scores which provide an indication of the quality of individual components, either hardware components and/or software components, of the device.

Once the initial log is captured, the system may initiate a continuous logging for the device that records, within a device log, information related to hardware and software components of the device. The continuous logging may capture information related to events of the device, where the events may affect a quality of the device or components of the device. The continuous logging may include logging of multiple logs that are aggregated into the device log. For example, each component may have a separate log that is utilized to record the information related to that component. As another example, certain events may have a unique log that records detection of that event. Such events could affect multiple components of the device.

The system updates the device logs based upon the continuous logging. Upon receiving a query for a device quality score, the system provides the device quality score utilizing the information stored within the device log. In other words, the system can dynamically determine, upon receiving a request for a device quality score, the device quality score using the information stored within the device log and in view of the initial log. Thus, the system can analyze what has happened to the device or components of the device as identified within the device log and determine what effect the information contained within the device log would have on the initial log information. In other words, using the initial log as a starting point, the system can determine how the quality of the device has been affected through the device log and then adjust the initial log, or initial device quality score, in view of the information contained within the device log. The device quality score can then be provided after this determination has been made.

Therefore, a system provides a technical improvement over traditional methods for identifying a quality of a device. Instead of making an assumption regarding a quality of a device, an entity can more accurately identify the quality of the device based upon events that have occurred to the device over a period of time. This allows the entity to identify those devices or components of devices that may still be usable for other purposes or that can be easily refurbished. Additionally, since the described system and method does not rely on time-consuming tests or inspections, additional cost is not incurred by an entity to make a determination regarding whether the device or components of the device can be salvaged. Thus, the described system and method provides a technique that allows for more informed decisions to be made regarding the disposition of devices or components of devices, thereby providing a more cost-effective disposition of devices and also reducing device waste.

The illustrated example embodiments will be best understood by reference to the figures. The following description is intended only by way of example, and simply illustrates certain example embodiments.

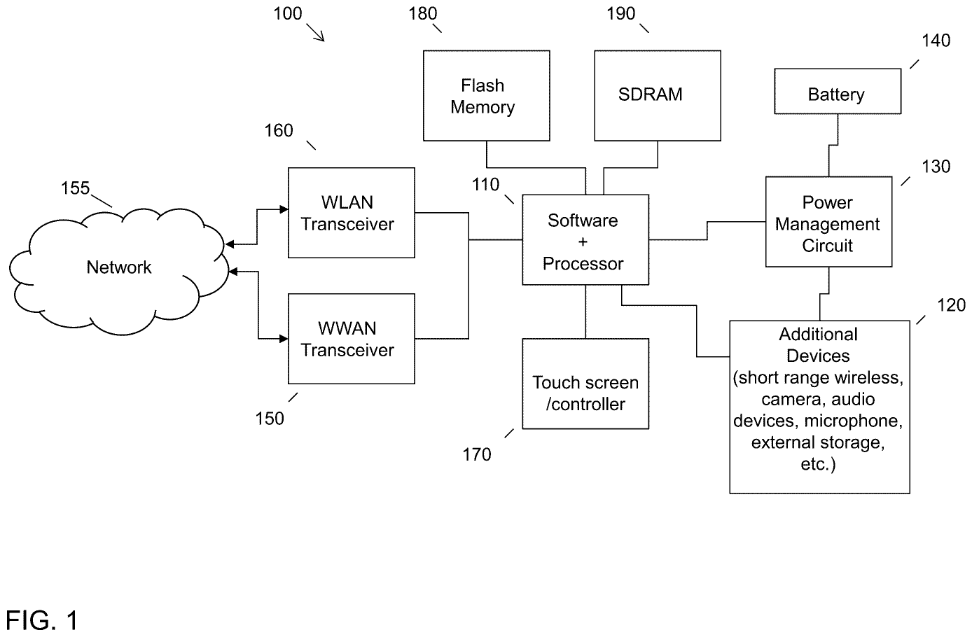

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

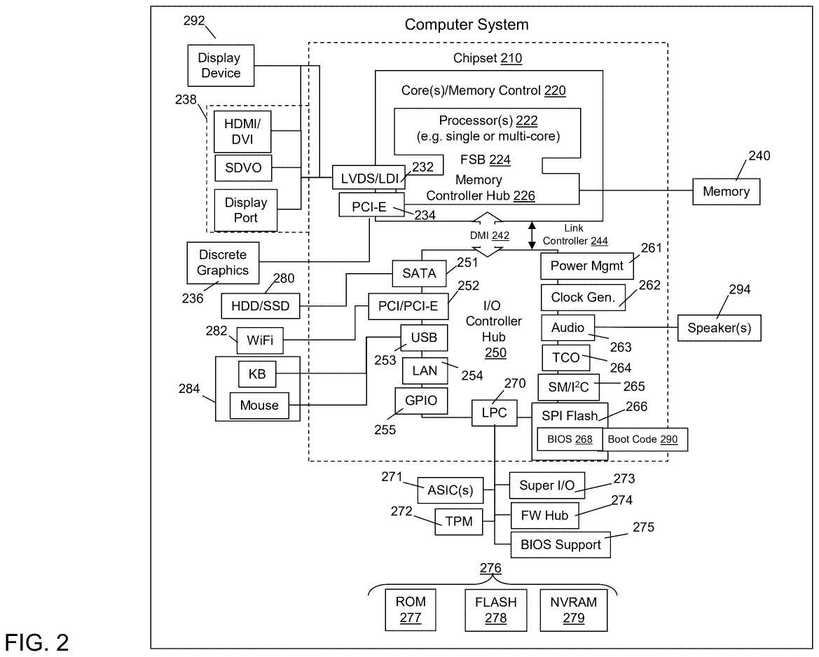

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices for which a quality score needs to be determined and provided, which may be used to access logs for a device to determine a quality score for a device, and/or the like. For example, the circuitry outlined in FIG. 1 may be implemented in a tablet or smart phone embodiment, whereas the circuitry outlined in FIG. 2 may be implemented in a personal computer embodiment.

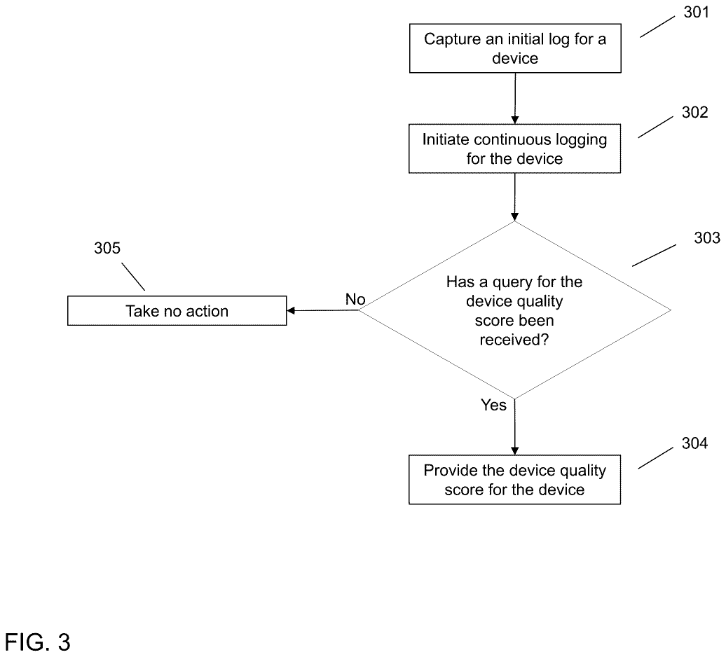

FIG. 3 illustrates an example method for determining and providing a device quality for a device based upon continuous logs that record information related to hardware and software components of the device. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to determine and provide a device quality score for a device. Additionally, the device quality analysis system includes modules and features that are unique to the described system.

The device quality analysis system may be activated in order to provide device quality scores for devices based upon device logs. The system can analyze the device logs to determine a quality of a device at a particular point in time. The system is able to determine the quality score of a device regardless of whether the device is directly accessible to the system or an entity running the system. The device logs can be stored in a data storage location (e.g., network, cloud network, system data storage location, etc.) that is accessible to the system and that allows the system to access these logs at any given time. The device logs can also be stored in a data storage location that may not be accessible to the system at any given time, for example, locally on the device, on a network that is not accessible to the system, and/or the like. In this case, the device logs could be accessed through a manual process where a user would access the data storage location and copy the files to a data storage location that is accessible to the device quality analysis system. Thus, the device quality analysis system could determine the device quality score from the device logs that are accessible to the system, even if those device logs may not be the most current device logs.

Activation of the device quality analysis system may be a manual activation of the device quality analysis system and/or an automatic activation of the device quality analysis system. Manual activation of the system may include a user opening an application associated with the device quality analysis system, the user accessing the computing system associated with the device quality analysis system, and/or the user otherwise providing input to the device quality analysis system. The automatic activation of the device quality analysis system may be based upon the detection of a trigger event indicating that the system should be activated. Example trigger events include expiration of a predetermined time period related to a device lease, a user accessing device or components logs, a user accessing an application that interfaces with the device quality analysis system, activation of software or an application utilizing the device quality analysis system, and/or the like.

The device quality analysis system may be made of multiple systems or modules that communicate together to make up the device quality analysis system or may be a single system. The device quality analysis system may be a standalone system, may be accessible through other computing devices, and/or a combination thereof. For example, the device quality analysis system may be a standalone system that can be accessed by a user and/or may be or provide an application that is accessible by a user on another computing device. The device quality analysis system may be accessible using any type of computing device, for example, personal computer, laptop computer, smartphone, tablet, smartwatch, head-mounted display, smart television or other smart appliance, augmented reality device, virtual reality device, and/or the like. Thus, the device quality analysis system may be accessible locally using a computing device where the device quality analysis system is installed and/or may be accessible remotely through another computing device. For example, the device quality analysis system may be accessed by a user using a device that communicates with the device quality analysis system to determine and provide device quality scores, access profiles for the device quality analysis system, access device and/or component logs for devices of a particular entity, and/or the like. However, the device quality analysis system may be located and operate on a different information handling device to perform the described steps.

The provision of device quality scores can be provided as a service to other entities or companies. In other words, the device quality analysis system could be stored on a server or network of a company and the system could determine and provide device quality scores for other companies or entities, with the other companies or entities paying for the provision of the device quality scores or use of the device quality analysis system. A company may also, or instead, pay for derivative information of the device quality scores. For example, a company can determine and provide device quality scores and then, from those scores, determine a useful life for devices. The company currently holding the devices may then pay for the information related to the useful life for the devices.

The device quality analysis system may have an associated graphical user interface. The graphical user interface may be provided on a display or monitor, which may or may not be associated with the device quality analysis system. In other words, the device quality analysis system may have a dedicated display or monitor or may be accessible using any display or monitor. In either case, the device quality analysis system may provide instructions to generate and display the graphical user interface on the display device being used to access the device quality analysis system. The graphical user interface may also be updated and managed based upon instructions provided by the device quality analysis system. In other words, the device quality analysis system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the device quality analysis system. For example, the device quality analysis system may utilize a device profile, company profile, historical information, and/or the like, to identify when to determine and provide device quality scores, when continuous logging should be initiated, how to disposition a device, and/or the like. The graphical user interface may allow for creation of or access to these profiles, historical information, and/or the like, by allowing a user to input information regarding user or device preferences, company information, and/or the like. As will be discussed in more detail, the use of user provided information is not the only way that the profile and/or historical information can be created. The device quality analysis system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, the device and/or component quality scores, device logs, and/or the like. It should be noted that the information to be used by the device quality analysis system and information provided by the device quality analysis system can be different for different applications, different computing systems, different users, and/or the like. Thus, the information corresponding to input or output of the device quality analysis system are not always the same. However, the device quality analysis system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The device quality analysis system may utilize one or more artificial intelligence models in determining and providing a device quality score. Artificial intelligence models could be designed to perform the quality score determination or calculation, perform some continuous logging to record information within the device log, or any other steps within the described system. Artificial intelligence models may also be used for steps within a step. For example, a model could be utilized to analyze the device logs to determine the device quality score, analyze and aggregated individual component quality scores to determine a device quality score, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the device quality analysis system or may be a model that is created from scratch. Since the device quality analysis system is used in conjunction determining and providing a device quality score, some models that may be utilized by the system are analysis models, similarity identification models, language models, large language models, filtering models, classification models, and/or the like. The model may be trained using one or more training datasets. Additionally, as the model is deployed, it may receive feedback to become more accurate over time. Alternatively, or additionally, the model may utilize inputs provided to the model to continually learn, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The device quality analysis system may include different components for carrying out different functions of the system, including different steps to be performed. These components may be hardware components or software components. Some hardware devices or components that may be utilized by the device quality analysis system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the device quality analysis system. For example, the device quality analysis system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the device quality analysis system, and/or the like.

One software component may include a data storage location that stores the information related to the devices and/or components of the devices. Information may be stored in the data storage location using any data storage technique. Additionally, the system can access the information stored within the data storage location using any type of querying technique, filtering technique, and/or the like. The information contained within the data storage location may also be organized, for example, grouped by device, grouped by company to which devices are leased, grouped by device or component quality scores, and/or the like.

Some other software components include the device or company profile that stores information related to a device or company and device or company preferences. Device information may include identification information (e.g., model, serial number, device identifier, manufacturer, etc.), information related to components of the device (e.g., software components, hardware components, etc.), initial or previously generated logs, initial or previously generated device quality scores, initial or previously generated component quality scores, and/or the like. The company information may include information related to what devices are currently being leased to the company. Additionally, the company information may identify preferences of the company in relation to how often device quality scores should be generated for the devices of the company, how often the company disposes of devices, a length of time associated with a lease of devices, and/or the like. It should be noted that not all companies that have a company profile may lease devices. Rather, the company could own, manufacturer, lease, or otherwise control devices. Thus, the information contained within a company profile can vary depending on how the company obtains or utilizes devices.

At 301, the device quality analysis system may capture an initial log for a device. It should be understood, that while a single device will be discussed herein, the system and method described herein can be utilized for multiple devices, groups of devices, and/or the like. However, each device will have a corresponding log, device log, quality score, and/or the like. Thus, the described system and method can be iteratively performed for multiple devices, with the information for each device being stored in a data storage location and being associated with the appropriate device. The initial log may be captured for the device at a predetermined time or responsive to detecting a trigger event. The trigger event may correspond to an event that is occurring with the device, for example, the device being scheduled to be shipped to another company or entity, the device being scheduled for storage, the device being taken out of storage, at predetermined intervals, and/or the like.

The initial log may provide information related to hardware and software components of the device. Thus, the initial log may be captured before an event occurs with the device that would cause the information related to the hardware and software components to change. In other words, if the device is going to be put into use, the information contained within the initial log related to the hardware and software components will change due to the use of the device. Accordingly, the initial log may be captured before the device is put into use. It should be noted that the initial log could be captured at any point in the device lifespan and not just at the very beginning of the device lifespan, for example, immediately after manufacture. Rather, the initial log is used as a baseline log for the device. Thus, the term initial refers to a log that occurs before the continuous logging of 302 and does not necessarily only refer to a log that occurs at the beginning of the device lifespan. In other words, an initial log may correspond to an event to which continuous logging will be initiated and for each event where continuous logging will be initiated, an initial log will be captured.

Throughout the lifespan of the device, multiple initial logs could be captured. For example, if a device is manufactured and then leased to another company, an initial log could be captured for the device before the device is actually shipped to or turned over to the company. At the end of the lease, the device may be brought back to the manufacturing company. The manufacturing company may store the device, refurbish the device, and/or the like, and then may lease the device to a different company. Before the device is turned over to this company, another initial log may be captured of the device. In this example, the device would then have two different initial logs, one occurring before turning the device over to the first company and one occurring before turning the device over to the second company. As could be understood, many different of these events could occur and, thus, more than two initial logs could exist for a given device.

It should be noted that since there may be multiple different initial logs, information can change between the initial logs due to the utilization of the device. Thus, presumably, the information contained within the initial logs would indicate that the usefulness or quality of the device has gone down between subsequent occurrences of the initial logs. However, it should be noted, that the information contained within the initial could indicate that the usefulness or quality of the device has gone up between subsequent occurrences of the initial logs. For example, a device may be refurbished or a component of the device may be replaced. In this case, the events that affected the device or the past component would be not be applicable to the refurbished device or replaced component. Thus, in this case, the initial log would reflect the change in the device or component and would show an increase in the usefulness, lifespan, or overall quality of the device or component.

The initial log may contain information related to hardware and software components of the device. Hardware and software components of the device may include, but are not limited to, processors, firmware, applications installed on the device, operating system, memory, display screens, touch pads, keyboards, fans, motherboards, ports, connectors, speakers, microphones, image capture devices, transmitters, receivers, and/or any other type of software or hardware of the device. The initial log may include information that corresponds to hardware and software logs of the device. Hardware and software logs are generally records that identify events that have occurred to a corresponding hardware or software component. Some logs may correspond to multiple hardware or software components or a combination of hardware and software components.

The events that are recorded within hardware and software logs may vary based upon the corresponding hardware and/or software component(s) that are reflected by the log. Some example events that may be recorded include, but are not limited to, component power cycling, component speed adjustments, component log in/log out events, vibration events, component alerts, component failures, component reboot events, component transmissions, component communication receipts, security events, component activity, detected location positions, detected device movements, and/or the like. Hardware and software logs may include system logs, security logs, application logs, event logs, audit logs, and/or the like. In other words, logs may include any information related to a hardware and/or software component(s) and any event affecting the hardware and/or software component(s). Thus, the information related to the hardware and software components may include any information related to events and alerts of the hardware and software components.

While the initial log may contain any and/or all of the information corresponding to the hardware and/or software logs of the device, a user or other entity may select specific hardware and/or software logs to be included or prioritized within the initial log. In other words, a user or entity may only be interested in logs that are related to specific events, specific components, and/or the like. In this case, the user or entity can identify those events, components, and/or the like, for the initial log and the initial log can then only include the identified events, components, and/or the like. Thus, the initial log could be customized based upon what a user or entity wants to track. For example, the user or entity may only want to track events that affect the motherboard of the device. Thus, the user or entity could identify the motherboard as the focus of the initial log, and the initial log would then only include the information from the hardware and/or software logs that are related to the motherboard.

In addition to capturing the initial log for the device, the device quality analysis system may also determine an initial component quality score and/or initial device quality score based upon the information contained within the initial log. Determining the initial component quality score and/or initial device quality score may be performed using the one or more artificial intelligence models, a rules engine, and/or the like. The system may determine component quality scores for different components of the device. For example, the system could determine an individual component quality score for the motherboard, fan, firmware, operating system, display, memory, and/or the like. To determine the initial quality score, for either the device or an individual component, the system may identify events within the hardware and software logs that add to or subtract from a baseline score value. For example, when a device is first manufactured, the device and/or components of the device may be assigned a perfect score. Upon powering on the device, hardware and software logs may be captured that identify events occurring within the device and to particular hardware and/or software components on the device.

As different events occur, certain events may be considered negative events that would decrease the quality of a component. In some cases, a single occurrence of an event may not have any effect on the quality of a component. However, a predetermined number of the same or similar events occurring, may have an effect on the quality of the component. Thus, as a predetermined number of the same or similar events occur (which could be a single occurrence, depending on the event), the quality of the component may decrease. Accordingly, the system can identify these events, a number of occurrence of these events, and/or the like, and then change the baseline quality score accordingly. Events that would decrease the quality of a component, for example, thermal events, alert events, power cycles, vibrations, alarm events, reboots, failure events, and/or the like, would result in a decrease in the quality score. Events that would increase the quality of a component, for example, component replacement, component updates, little or low movement of the device, and/or the like, would result in an increase in the quality score.

Events that decrease and increase the quality of a component or device can be stored within a rules database, identified using an artificial intelligence model, identified from a secondary source (e.g., Internet site, device manual, technology paper or resource, etc.), and/or the like. Events that decrease and increase the usefulness or lifespan of a component or device are identified from the initial log, or from a previously generated log, and are then used to increase and decrease the initial component and/or device quality score. Thus, as previously mentioned, the initial device quality score and/or initial component quality scores could go up or could go down as compared to other initial device quality scores and/or initial component quality scores that have been previously determined for the device or components of the device.

The initial device quality score can be determined as a standalone quality score or may include aggregating the initial component quality scores into a single device quality score. In other words, the device quality analysis system can determine an initial component quality score for each of the hardware components and software components of the device and then aggregate these initial component quality scores into a single device quality score. It should be noted that initial component quality scores do not have to be determined for each and every hardware and software component of the device. Rather, a user or other entity could identify the components for which component quality scores are to be determined, the components for which quality scores are determined may a default selection of components, and/or the like. Thus, if the initial device quality score is determined by aggregating the component quality scores, it may be an aggregation of those component quality scores that are determined and may not include every component of the device.

At 302, the device quality analysis system may initiate continuous logging for the device. The continuous logging may record, within a device log, information related to hardware components and software components of the device. In other words, the continuous logging updates a device log with information related to the components of the device. The information contained within the device log or that is captured with the continuous logging may be any of the information that was previously discussed with respect to the initial log. The device log may include the initial log, or may be a separate log. The device log may include identifiers of the device so that when the device log is stored in a data storage location it can be associated with the initial log, or any other logs, related to the device. The device log may be updated in real-time as the device is utilized.

The device log may be stored at a data storage location that is directly accessible by the device quality analysis system, or the device log may be stored at a data storage location that requires intermediate access and data transfer to the device quality analysis system. For example, if the device log is stored in a data storage location that is directly accessible to the device quality system, the device quality system can analyze the device logs as they are updated in real-time or near real-time. If the device log is stored in a data storage location that requires intermediate access and data transfer to the device quality analysis system, the device log may still be updated in real-time as the device is used, but the device log may only be provided to the device quality analysis system periodically. The choice of data storage location where the device log is stored may be dependent upon the entity in control of the device. For example, some entities may allow network access to the device quality analysis system, thereby permitting the device quality analysis system to access the device log on a real-time or near real-time basis.

As another example, some entities may not allow network access to the device quality analysis system, which means that the device log would be stored in a data storage location that is only accessible at or by the entity. Thus, to access such device logs, a user (e.g., a user associated with the device quality analysis system and/or device provider) might have to request and obtain access to a network managed by the entity. The user could then copy the device logs to a memory device or other data storage device that the user could then connect to a network of the device quality analysis system and add the files to a data storage location accessible to the device quality analysis system so that the system could access the device logs. In some embodiments, the device logs may be stored on the device itself and whenever the device accesses a network, either accessible to the system or not, the device could copy the logs to a data storage location on the network, provided the device has been programmed to do so and the network and data storage location are designated networks and data storage locations for device log copying.

The information related to the hardware and software components may include events that occur to the device or components of the device that may affect a quality of the device or components of the device. Thus, the continuous logging may be a logging similar to traditional device logs, as previously mentioned. Additionally, the continuous logging may not be something that is separate from the event logging of traditional methods. Rather, the continuous logging may simply cause the event logging of traditional methods to be stored within a single data storage location. In other words, by initiating the continuous logging, the event logging may be stored within a single accessible location, even if the event logging might normally be stored within multiple separate locations. The continuous logging may or may not include all event logging, but may only include event logging that is related to or that corresponds to particular hardware or software components, for example, those identified previously.

The continuous logging may only include logging event data that has occurred since the capture of the initial log. In other words, unlike traditional event logging which captures all events that have occurred since the manufacture of the device, the continuous logging will only capture the events that have occurred since the capture of the initial log. Thus, the continuous logging is initiated since the time of the initial log. Accordingly, since the device may have multiple initial logs, the device may also have multiple continuous logging or multiple device logs that correspond to a continuous logging initiation, with each continuous log and/or device log that corresponds to an initial log.

At 303, the device quality analysis system, determines if a query for the device quality score has been received. Receipt of a query may be based upon a trigger event, or may be performed using the graphical user interface of the device quality analysis system. The device quality analysis system may present a graphical user interface that allows a user or entity to provide queries regarding device or component quality scores. Within the graphical user interface, the user can provide information to identify which device, or devices, for which quality scores should be determined. While each device will have an individual device quality score, the graphical user interface could allow the user to provide input identifying more than one device for which to determine a quality score. Thus, and for example, if the user or entity wants quality scores determined for all the devices that are currently in possession of a particular entity, the user or entity could provide this input to the graphical user interface instead of having to identify each device individually. As an example, a first entity may lease devices to a second entity and at the end of the lease term, the first entity may request that all devices having a lease term expiring within a predetermined time frame have quality scores calculated for them.

Since the system can also calculate component quality scores, the user query may additionally, or alternatively, identify particular components of devices for which to determine a quality score. As with the devices, the graphical user interface could allow the user to selects groups of components, more than one component, all components of a particular type, all components affected by particular events, and/or the like. Thus, as with the devices, the user would not have to identify each component individually. Once the system determines the quality score either for the device, for the component, or for both, the system may provide the quality score within the graphical user interface.

If a query for the device quality score has not been received at 303 (no branch from 303), the system may take no action with respect to determining and presenting a device quality score at 305. The device may further continue the continuous logging and continue to update the device log either in real-time or periodically, depending on the data storage location of the device log.

On the other hand, if a query for the device quality score has been received at 303 (yes branch from 303), the device quality analysis system may provide the device quality score for the device at 304. In other words, the device quality analysis system may provide, responsive to receiving a query requesting a quality score, a device quality score for the device and/or a component quality score for a component of the device. To determine the device quality score and/or component quality score, the system may dynamically determine the device (or component) quality score based upon the information contained within the device log and in view of the initial log. Dynamically determining the quality score (either for the device, the component, or both), means that the quality score is determined upon receipt of the query. In other words, the system determines the quality score when the query is received making the quality score a real-time quality score.

However, as noted previously, the real-time updated device log may or may not be stored in a data storage location that is accessible to the device quality analysis system. If the real-time updated device log (meaning the device log that is stored in the accessible location is updated in real-time as the device is utilized) is stored in an accessible data storage location, upon receiving the query, the system may access the real-time updated device log from the accessible network location in real-time and then determine the quality score based upon this real-time access of the device log. Additionally, since this log is being updated in real-time as the device is being utilized, this device log will have the most up-to-date information with respect to information affecting the hardware and software components.

On the other hand, if the device log that is stored within the accessible location is not the real-time updated device log (meaning the device log that is updated in real-time is in a data storage location not accessible to the system), the system will access the latest version of the device log that is accessible to the device quality analysis system and then determine the quality score utilizing this latest version of the device log. Thus, while this device log, and therefore quality score, would likely not have the most up-to-date information with respect to information affecting the hardware and software components, the quality score is as up-to-date as possible based upon the accessibility of the device log that is being updated in real-time. In this case, the user may wish to determine quality scores for devices and/or components as soon as a new device log has been provided to an accessible location. However, this is not strictly necessary as the system could determine the quality score at any time after a device log has been put in an accessible data storage location.

To determine the device (or component) quality score, the system may utilize any of the techniques as previously discussed with respect to determining the initial device (or component) quality score. Thus, when determining the quality score, increasing or decreasing the quality score may be done based upon any of the factors as previously discussed with respect to the initial device (or component) quality score. Determining the quality score may be performed in view of the initial log, meaning that the initial log is used as the baseline for determining the quality score. Thus, increasing and decreasing the quality score is based upon information that has occurred since the initial log was captured. The quality score that is increased or decreased is the initial quality score that was determined. As with the initial quality score, the device quality score may be computed either separately or may be computed by aggregating component quality scores into the device quality score.

In addition to determining and providing the quality scores, the system may store the quality scores in a data storage location. Storing the quality scores may include storing the component quality scores separately from the device quality score. However, the component quality scores and device quality scores may be associated so that they can be accessed at the same time. In other words, the component quality scores and device quality scores may be stored individually so that a user could access either the device quality scores and/or component quality scores as the need may arise.

As an overall non-limiting example of the described system, a device manufacturer company, Company M, may lease devices to other companies, for example, Company L. Upon the start of the lease and before the devices are shipped to Company L, Company M captures initial logs for the devices and initiates the continuous logging of the devices. Thus, the initial log is captured before the device is transferred from the first entity, Company M, to the second entity, Company L, whereas the continuous logging of the devices occurs while the device is possessed by the second entity, Company L. The lease of the devices has a predetermined time period and at the end of the time period, the devices will be returned back to Company M. Company L may then lease new devices from Company M. Company M normally disposes of the devices by having a third-party refurbishment company, Company R, obtain the devices from Company L and take them to Company R, without the devices being returned to Company M. Company R pays Company M for these devices.

However, using the described system, once the lease is close to expiration, Company M may cause the device quality analysis system to determine a device quality score for the devices and provide these device quality scores. Company M may review the devices quality scores, and individual component quality scores for the devices, to determine if, instead of being sold to Company R, the devices should be returned to Company M for internal refurbishment or for storage in the case that some components could be used for service work. Based upon the device quality scores, Company M decides to provide a subset of these scores to Company L to encourage Company L to keep some of the devices that still have good quality scores and that are still meeting the needs of Company L. For other of the devices, Company M decides to bring them back to the Company M for internal refurbishment and storage. For other of the devices, Company M sells them to Company R, and has Company R obtain them from Company L, without bringing the back to Company M.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
capturing, using a device quality analysis system, an initial log for a device, wherein the initial log comprises information corresponding to hardware and software logs for the device;
initiating, for the device, a continuous logging that records, within a device log, information related to hardware components and software components of the device; and
providing, responsive to receiving a query, a device quality score for the device, wherein the providing comprises dynamically determining, using the device quality analysis system, the device quality score based upon the information contained within the device log and in view of the initial log.

2. The method of claim 1, further comprising determining an initial device quality score for the device based upon the initial log, wherein the determining the initial device quality score comprises determining an initial component quality score for each of the hardware components and software components of the device and aggregating the initial component quality scores into the initial device quality score.

3. The method of claim 1, wherein the determining the device quality score comprises determining a component quality score, based upon the device log, for each of the hardware components and software components and aggregating the component quality scores into the device quality score.

4. The method of claim 3, comprising storing each of the component quality scores for the device in a data storage location.

5. The method of claim 1, wherein the device log is stored within a network location that is accessible by the device quality analysis system and is updated in real-time as the device is utilized; and
wherein the providing the device quality score comprises accessing the network location and dynamically determining the device quality score utilizing the device log updated in real-time.

6. The method of claim 1, wherein the device log is stored within a data storage location that is not accessible to the device quality analysis system and is updated in real-time as the device is utilized;
wherein the device log is provided to the device quality analysis system periodically; and
wherein the providing the device quality score comprises accessing a latest version of the device log accessible to the device quality analysis system and dynamically determining the device quality score utilizing the latest version of the device log.

7. The method of claim 1, wherein the information related to the hardware components and software components comprise information related to events and alerts of the hardware components and software components.

8. The method of claim 1, further comprising providing a graphical user interface, wherein the providing the quality score comprises providing the quality score within the graphical user interface.

9. The method of claim 1, wherein the capturing the initial log is performed before the device is transferred from a first entity to a second entity and wherein the continuous logging occurs while the device is possessed by the second entity.

10. The method of claim 1, further comprising determining, based upon the device quality score, a disposition for the device.

11. A system, the system comprising:
a processor;
a memory device that stores instructions that, when executed by the processor, causes the system to:
capture, using a device quality analysis system, an initial log for a device, wherein the initial log comprises information corresponding to hardware and software logs for the device;
initiate, for the device, a continuous logging that records, within a device log, information related to hardware components and software components of the device; and
provide, responsive to receiving a query, a device quality score for the device, wherein the providing comprises dynamically determining, using the device quality analysis system, the device quality score based upon the information contained within the device log and in view of the initial log.

12. The system of claim 11, further comprising determining an initial device quality score for the device based upon the initial log, wherein the determining the initial device quality score comprises determining an initial component quality score for each of the hardware components and software components of the device and aggregating the initial component quality scores into the initial device quality score.

13. The system of claim 11, wherein the determining the device quality score comprises determining a component quality score, based upon the device log, for each of the hardware components and software components and aggregating the component quality scores into the device quality score.

14. The system of claim 13, comprising storing each of the component quality scores for the device in a data storage location.

15. The system of claim 11, wherein the device log is stored within a network location that is accessible by the device quality analysis system and is updated in real-time as the device is utilized; and
wherein the providing the device quality score comprises accessing the network location and dynamically determining the device quality score utilizing the device log updated in real-time.

16. The system of claim 11, wherein the device log is stored within a data storage location that is not accessible to the device quality analysis system and is updated in real-time as the device is utilized;
wherein the device log is provided to the device quality analysis system periodically; and
wherein the providing the device quality score comprises accessing a latest version of the device log accessible to the device quality analysis system and dynamically determining the device quality score utilizing the latest version of the device log.

17. The system of claim 11, wherein the information related to the hardware components and software components comprise information related to events and alerts of the hardware components and software components.

18. The system of claim 11, further comprising providing a graphical user interface, wherein the providing the quality score comprises providing the quality score within the graphical user interface.

19. The system of claim 11, wherein the capturing the initial log is performed before the device is transferred from a first entity to a second entity and wherein the continuous logging occurs while the device is possessed by the second entity.

20. A product, the product comprising:
a computer-readable storage device that stores executable code that, when executed by a processor, causes the product to:
capture, using a device quality analysis system, an initial log for a device, wherein the initial log comprises information corresponding to hardware and software logs for the device;
initiate, for the device, a continuous logging that records, within a device log, information related to hardware components and software components of the device; and
provide, responsive to receiving a query, a device quality score for the device, wherein the providing comprises dynamically determining, using the device quality analysis system, the device quality score based upon the information contained within the device log and in view of the initial log.
